(19) United States
(12) Patent Application Publication
(10) Pub. No.: US 2008/0173258 A1
(43) Pub. Date: Jul. 24, 2008

(54) Protective foot and leg cover guard for wounds and allergies

(76) Inventor: Eunice Franco, Lake Worth, FL (US)

Correspondence Address: Eunice Franco, 6259 Shadow Tree Ln., Lake Worth, FL, 33463, US

(21) Appl. No.: 11/595,871

(22) Filed: Jan. 22, 2007

(51) Int. Cl. A01K 13/00

(52) U.S. Cl. 119/850

(57) ABSTRACT

The Protective Foot and Leg Cover Guard is a sock-like, one-piece garment that the animal's front or rear leg can slide into. There are no wraps or clasps. The leg simply slides into it. It has an adjustable clasp that joins in back of the neck far from the animal's potential reach. Therefore, it is impossible for the animal to remove it or break the clasp. It is for dogs and cats and other four legged animals. Mainly to be used to cover a bandaged leg and/or foot and prevents the animal from licking, biting, scratching or removing bandages. It allows a cut or injury to heal undisturbed. The fabric is the same fabric used on muzzles—durable nylon. No need to put the animal in a brace or apparatus of any kind. It is bendable, but not easily ripped and washable.

### CROSS-REFERENCE TO RELATED APPLICATIONS

Application Ser. No. 11/595,871

Filing or 371© Date: Nov. 13, 2006

First Named Applicant: Eunice Franco

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING COMPAQ DISC APPENDIX

Not Applicable.

### BACKGROUND OF INVENTION

This invention applied to leg protection for animals. Various protective apparatus have been proposed in the past for protecting the legs of animals such as dogs and cats. Although assumably effective in use, they are not secure since a dog or cat will remove any clips or wraps at their reach. If the apparatus is not one unit, the animal will find something to chew on and eventually remove it. This is especially true if it is fastened around the leg and secured with Velcro or the like. Also, having any hooks available to the animal to play with may eventually lead to the animal chewing parts of it off and swallowing it. It is therefore dangerous to design this with any straps or hooks that are not behind the animal's neck.

Therefore, this offering is different in that it is a one-piece unit made of durable material that cannot be removed. It is not removable by the animal since it is one solid ‘sock-like’ unit. No edges to pick on or Velcro to remove or ties of any kind available to the animal. Only an adjustable hook on the top of the neck. It is therefore safe for the animal since no parts can be chewed off and swallowed leading to choking or death. It is for both front and rear legs. It is for both cats and dogs. The foot area is also protected. Animals typically will chew on their feet as well. This product prevents that. The simple design makes for easy manufacturing and thus affordability. It is easy to make and cheaply distributed.

The product would be a garment or sock that allows the sliding of the animal's front or rear leg into it. It can be used to protect the entire leg and foot of an animal. It is non-restrictive.

### BRIEF SUMMARY OF THE INVENTION

A sock-like garment that an animal's leg can be slipped into with two straps that join behind the neck (over the shoulders of the animal). This clasp will be unreachable by the animal. This leg and foot cover guard allows the pet owner to properly clean, medicate and cover the wound and then assure that the pet will not remove the bandage and medicine. It is a protective shield. It can be used in the front or rear legs.

When a dog or cat gets a cut, it has a tendency to lick, bite, and scratch it and make it worse. If the pet owner attempts to cover the wound with medicine and a bandage, the pet will eventually chew the bandage off and then start to chew or aggravate the wound thus making it impossible for it to heal and may even cause infection and a trip to the vet.

### BRIEF DESCRIPTION OF THE SEVERAL VIEWS OF THE DRAWING

FIG. 1 Description: This figure shows how the guard is similar to a sock. It simply slides over the animal's leg until it reaches the torso of the animal. The appropriate size needs to be selected to fit the length of the leg. The straps are adjustable and reach behind the neck of the animal and clip together. The material for the guard is similar to that used in muzzles, a nylon that is tough to chew through but is washable.

FIG. 2 Description: This figure shows a front view of how the guard would fit on an animal's leg and tie above the neck.

FIG. 3 Description: This figure shows how a doctor would bandage the animal's leg with gauze and tape. Possibly followed by more bandage. This is extremely tempting to the animal to play with and remove. It needs to be covered and become unobtainable to be effective in allowing healing.

FIG. 4 Description: This figure shows a side view of how the guard would fit on an animal. The bandage underneath (shown in FIG. 3) would remain protected.

### DETAILED DESCRIPTION OF THE INVENTION

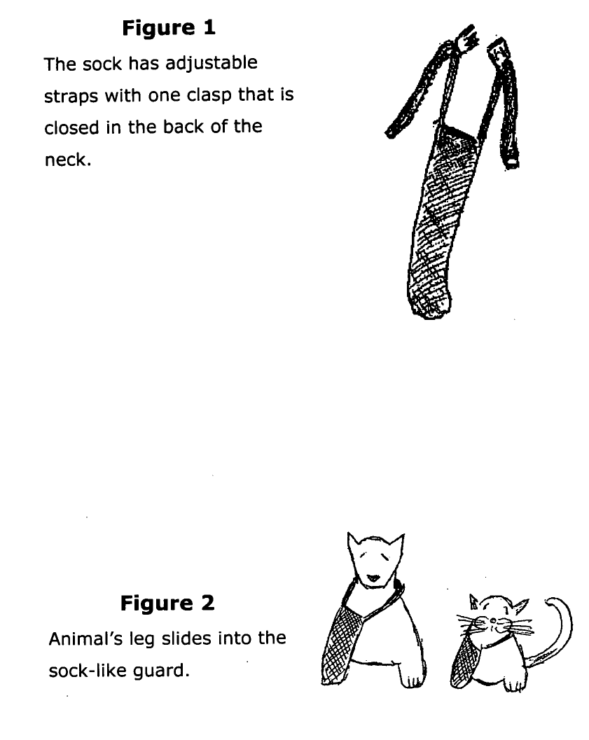

The body of the invention is manufactured like any sock would be. It is made of durable, thick, pliable nylon. As noted in FIG. 1, it is exactly as a sock. Attached to the sock would be straps with a sliding clasp that allow the garment to adjust to different size animals. The clasp would lie on the neck of the animal thus being totally out of the animal's reach.

This garment may be worn by most four legged animals. FIG. 2 shows a front view of a cat and a dog wearing it. It may be worn on any leg. It is used for protecting the feet as well.

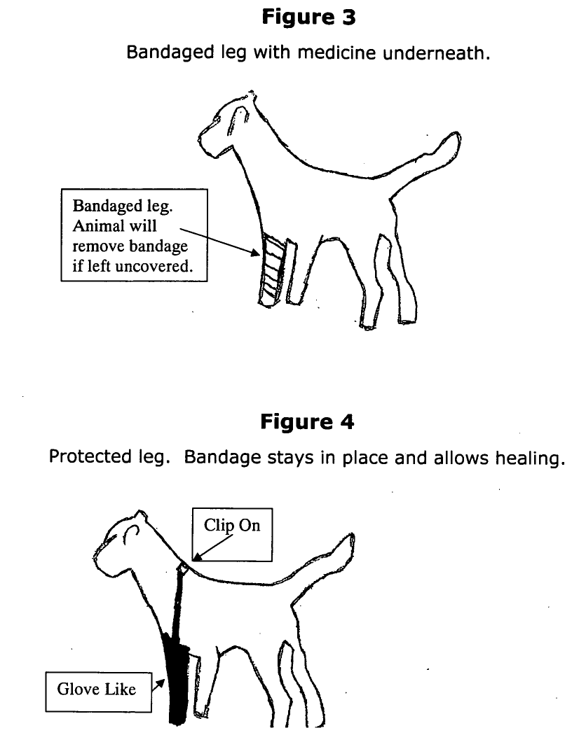

FIG. 3 shows how a wound would be covered by a veterinarian or a pet owner. This bandage would easily be removed by the animal. Covering it as shown in FIG. 4 would provide optimal protection and comfort at the same time.

Having described the invention, what is claimed as new and desired to be secured by the patent is the following:

1. This product is a cover for a dog or cat's entire front or rear leg and foot available in various sizes to accommodate different size legs with an adjustable straps at the back of the neck with a clip to enable adjustment to the proper size and for ease of use.

2. It does not have clasps or straps on the body of the sock or unit.

3. It may be offered in different fabrics, however, the ideal would be a durable, thick, pliable nylon that is also washable (similar to the material used for muzzles)—the sock like unit is a simple unit with no buckles or straps that a pet may chew on and remove.

4. It is a simple unit with straps that adjust.

5. Additionally, it offers the following: protection that prevents infection, comfort, and extremely easy to use for the pet owner to cover bandages and medicines, durability, washable.

6. Ideal for aiding in the treating of allergies and wounds.
